(19) United States
(12) Patent Application Publication
(10) Pub. No.: US 2015/0303555 A1
(43) Pub. Date: Oct. 22, 2015

(54) MANUFACTURING METHOD OF NONPLANAR 3D ANTENNA SHAPING

(71) Applicant: NATIONAL CHUNG SHAN INSTITUTE OF SCIENCE AND TECHNOLOGY, Longtan Township (TW)

(72) Inventors: CHI-HAW CHIANG, LONGTAN (TW); REN-RUEY FANG, LONGTAN TOWNSHIP (TW); MENG-BIN LIN, LONGTAN TOWNSHIP (TW)

(21) Appl. No.: 14/551,227

(22) Filed: Nov. 24, 2014

(30) Foreign Application Priority Data
Apr. 16, 2014 (TW) 103113784

(51) Int. Cl. H01Q 1/38; C23F 1/02; C23C 18/38; H01Q 1/36

(52) U.S. Cl. CPC H01Q 1/38; H01Q 1/36; C23F 1/02; C23C 18/38

(57) ABSTRACT

A manufacturing method of nonplanar 3D antenna shaping includes providing a nonplanar insulating substrate; performing coarsening and modification on the surface of the substrate, followed by rendering the substrate surface hydrophilic in a plasma process to form a modified substrate; performing copper electroless plating on the modified substrate to plate a copper layer on the substrate, so as to achieve a required thickness. The width of the metal wiring is efficiently reduced to microscale by 3D photolithography; therefore, the range of its low-frequency application is reduced to less than 2 GHz. The method involves controlling substrate surface coarseness uniformity, modifying the substrate surface hydrophilic, and applying a precise plating technique with a view to enhancing the quality of copper wire coating. The method not only enhances antenna low-frequency performance but is also conducive to miniaturization of antennas, thereby allowing a tool carrying an antenna to reduce weight and power consumption.

### CROSS-REFERENCE TO RELATED APPLICATION

This non-provisional application claims priority under 35 U.S.C. §119(a) on Patent Application No(s).103113784 filed in Taiwan, R.O.C. on Apr. 16, 2014, the entire contents of which are hereby incorporated by reference.

### FIELD OF THE INVENTION

The present invention relates to manufacturing methods of antenna shaping, and more particularly, to a 3D antenna wiring shaping method for controlling substrate surface coarseness uniformity , modifying the substrate surface, and applying precise plating techniques with a view to enhancing the quality of copper wire coating, and a 3D antenna shaping method based on 3D photolithographic processing.

### BACKGROUND OF THE INVENTION

According to the prior art, in a wireless communication system, an antenna serves as an intervening point between a transceiver and a communication environment and is capable of converting voltage, current, and electromagnetic field signals and changing the distribution of electromagnetic waves in a space. Due to the development of various novel wireless communication specifications and apparatuses, functions of antenna components are increasingly important. Mobile communication apparatuses require antennas increasingly, and thus various antennas are developed to receive signals of different frequencies; in this regard, six or more antennas are used to meet the needs for various signals.

Regarding 3D antenna manufacturing methods, U.S. Pat. No. 7,944,404B2 discloses a circular helical 3D antenna manufacturing method which involves etching slightly a quarter fan-shaped dielectric board along its circumference and at specific intervals with a cutting tool to form a plurality of arcs on the dielectric board, wherein conductor arcs are shaped by a technique of transferring a conductive material, and eventually a hollow-core circular antenna is formed from the fan-shaped dielectric board by a welding method. U.S. Pat. No. 7,038,636B2 discloses a circular helical 3D antenna manufacturing method, wherein a helical antenna has a helix support, such as a flexible support, fixed mechanically in place by a substrate with three anti-electrostatic plates, wherein helical conductive wires are fixed to the circumference of the flexible anti-electrostatic plates with an adhesive in a manner that the helical conductive wires are spaced apart from each other by a through hole, so as to prevent the helical wires from coming into contact with each other to develop a short circuit. U.S. Pat. No. 6,917,346B2 discloses processing a conductive material to form a fan-shaped 3D antenna with folded wires. U.S. Pat. No. 6,788,271B1 discloses using a roller mechanism to apply a conductive material paste to a cylindrical surface, wherein the cylinder moves at an axial speed while rolling, such that helical conductive wires on the cylindrical surface are spaced apart from each other by a specific gap, so as to form a helical 3D antenna. U.S. Pat. No. 5,349,365 discloses a bent conductive metal wire circuit board and discloses forming a helical antenna by a conventional soldering process.

Both U.S. Pat. No. 4,945,363 and U.S. Pat. No. 4,675,690 disclose manufacturing a helical wiring antenna on a flexible substrate, and the seams on two sides of the substrate are joined, folded, and fixed in place with an adhesive fabric or a bolt, wherein the conductive wiring manufacturing method is implemented by photoresist shielding and a chemical etching process rather than an integral shaping antenna manufacturing process, but the helical wiring antenna is manufactured by additional joining. Both U.S. Pat. No. 4,163,981 and U.S. Pat. No. 3,564,553 disclose manufacturing an antenna by winding a helical conductive wire around a rod-shaped circular substance at equal or unequal intervals. U.S. Pat. No. 6,288,686B1, U.S. Pat. No. 5,479,180, and U.S. Pat. No. 4,697,192 disclose winding two or more conductive metal strips around a fiberglass substrate or a dielectric material helically. Taiwan Patent M308809 discloses manufacturing a helical conductive wiring on a ceramic post-shaped body, wherein the post-shaped body is covered with the conductive wiring by a plating technique, and the conductive wiring is made of copper or gold, and helixes are in the number of one or two. All the aforesaid patents differ from the present invention in the processing method used. U.S. Pat. No. 6384799B1 discloses an antenna for use in mobile communication and its manufacturing method requires that a flexible substrate be wound to take on a cylindrical shape and fixed in place, wherein a skew continuous conducting wire is wrapped around the cylinder to form a helical antenna. The aforesaid patents mostly disclose that a conducting wire is wound around or adhered to a 3D antenna to finalize the formation of the 3D antenna.

As compared to conventional planar antennas, a nonplanar 3D antenna requires a processing process which is intricate and difficult. In particular, it is never easy to define antenna metal wiring width and clearance on a 3D substrate. The aforesaid metal wiring width and clearance have a great impact on the scope of application of antenna bandwidth. As a result, the industrial sector is currently in a quandary how to precisely define width and clearance and manufacture a helical 3D wiring on the 3D substrate.

In conclusion, existing patents pertaining to a nonplanar 3D antenna aim to manufacture a broadband nonplanar antenna on a nonplanar dielectric material or by coupling nonplanar antenna wirings together and therefore provide a nonplanar antenna wiring manufacturing method and a method for coupling it to a dielectric material. In a wireless communication system, an antenna serves as an intervening point between a transceiver and a communication environment and is capable of converting voltage, current, and electromagnetic field signals and changing the distribution of electromagnetic waves in a space. Due to the development of various novel wireless communication specifications and apparatuses, functions of antenna components are increasingly important. The wireless communication market is confronted with a great demand for the development of consumer mobile wireless communication products and a trend toward integration of various wireless systems in terms of devices and antennas. To meet the need for devices which are portable, pleasant, and compact, antennas not only have to be multi-band, ultra-broadband, or multi-antenna based when operating in a finite space, but also have to integrate with the other circuits, so as to attain high-performance or multifunction specifications. It is important to miniaturize antennas, maintain the other antenna-related characteristics, such as bandwidth, directivity, and radiation efficiency, and strike a balance between various types of performance.

The overview above and the description below explain the techniques and measures taken to achieve the objectives of the present invention and explain the effects of the present invention. The other objectives and advantages of the present invention are described below as well.

### SUMMARY OF THE INVENTION

In view of the aforesaid drawbacks of the prior art, it is an objective of the present invention to provide a manufacturing method of antenna shaping, comprising the steps of: providing a nonplanar 3D substrate ; performing coarsening and modification on a surface of the substrate to form a modified substrate and therefore enhance uniformity of back-end metal plated layer by surface treatment of the substrate; forming a copper layer on the modified substrate, followed by plating copper on a surface of the modified substrate with a precise plating bath to cover the copper layer, so as to enhance the quality of the copper plating of the modified substrate; and shaping an antenna metal wiring by 3D photolithography. According to the present invention, the antenna metal wiring width and clearance is defined by photolithographic shaping to efficiently reduce a width of an antenna metal wiring to microscale and therefore reduce a range of its low-frequency application to less than 2 GHz.

In order to achieve the above and other objectives, a substrate of the present invention undergoes pre-processing which includes: performing coarsening control and modification on the substrate surface; providing a non-conductor substrate, such as FR4, PI, teflon, or any other engineering plastic or ceramic substrate with satisfactory insulation properties; and performing precise surface coarseness control on the surface of the substrate by chemical etching or a mechanical means to achieve uniform and appropriate coarseness of the substrate surface. Second, impurities (slag and residues) are removed from the substrate chemically/mechanically. Due to their surface characteristics, some materials have a surface droplet contact angle larger than 90 degrees and therefore are hydrophobic; these materials undergo surface modification chemically or physically (a plasma process), such that these materials have their surface droplet contact angle reduced to less than 90 degrees and therefore are hydrophilic.

Copper electroless plating is performed on the substrate which has undergone surface coarsening control and modification to form on the substrate a copper electroless plating layer which is about 1 μm thick. Its steps are described below. First, the substrate surface is cleansed with acetone, and then the substrate undergoes sensitization and activation with SnCl₂ and PdCl₂. Afterward, the substrate is put in a copper electroless plating solution to undergo a copper electroless plating process. With a plating technique, a copper layer is deposited on the substrate surface to a required thickness for effectuating copper electroless plating thereon. Then, antenna wiring width and clearance is defined by photolithography. Afterward, antenna metal wiring shaping is performed with a conventional copper etching plating solution. Then, a 3D antenna with small width and clearance is defined easily on a single 3D substrate by semiconductor exposure and development technology, and it has a large applicable bandwidth and thus is highly practicable at high frequency and low frequency.

### BRIEF DESCRIPTION OF THE DRAWINGS

FIG. 1 is a flowchart of the present invention; and

FIG. 2 is a flowchart of an embodiment of the present invention.

### DETAILED DESCRIPTION OF THE PREFERRED EMBODIMENTS

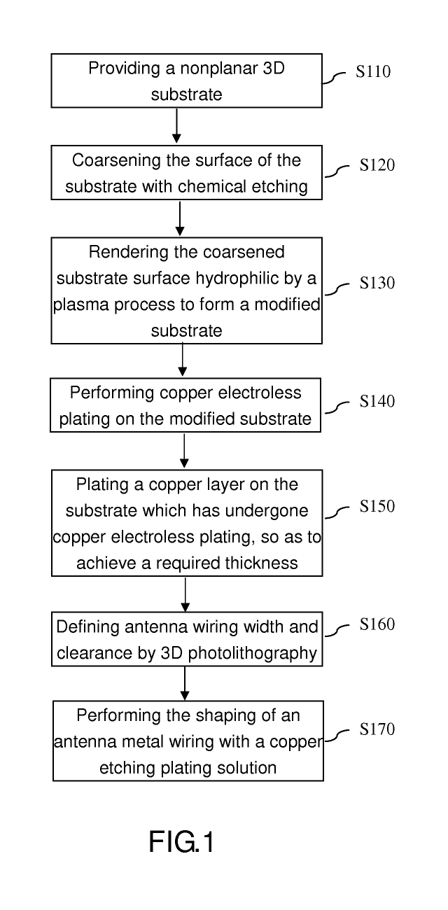

The implementation of the present invention is hereunder illustrated with specific embodiments. After studying the disclosure contained herein, persons skilled in the art can gain insight into the other advantages and effects of the present invention readily. Referring to the flowchart of FIG. 1, the present invention provides a manufacturing method of antenna shaping. The method comprises the steps of: providing a nonplanar 3D substrate S110; coarsening the surface of the substrate with chemical etching S120; rendering the coarsened substrate surface hydrophilic by a plasma process to form a modified substrate S130; performing copper electroless plating on the modified substrate S140; plating a copper layer on the substrate which has undergone copper electroless plating, so as to achieve a required thickness S150; defining antenna wiring width and clearance by 3D photolithography S160; and performing the shaping of an antenna metal wiring with a copper etching plating solution S170. Accordingly, the applicable bandwidth of the 3D antenna of the present invention is 2-18 GHz, and the manufacturing method of the present invention ensures that the substrate surface coarseness is uniform, wherein a precise plating bath enhances the quality of copper plating.

### Embodiment 1

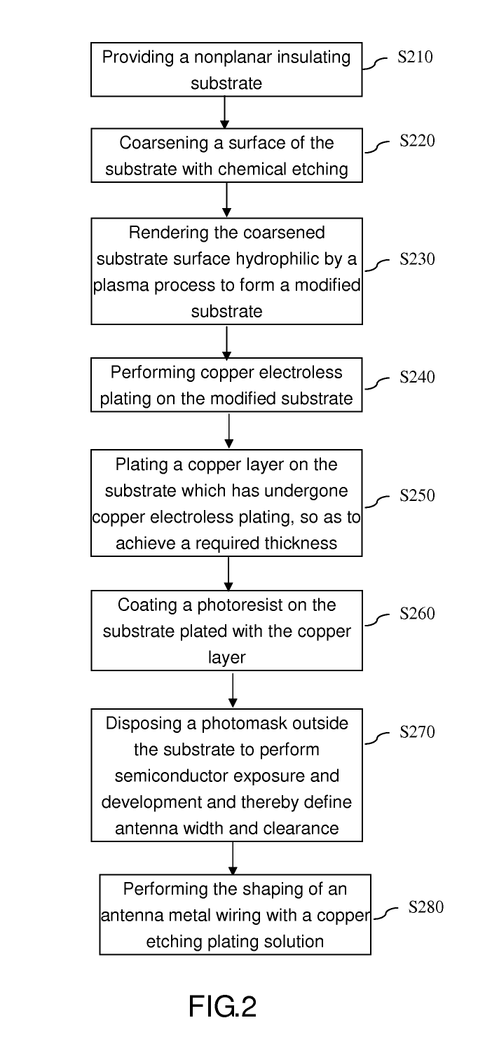

Referring to FIG. 2, there is shown a flowchart of an embodiment of the present invention, comprising the steps of: providing a nonplanar insulating substrate S210; coarsening a surface of the substrate with chemical etching S220; rendering the coarsened substrate surface hydrophilic by a plasma process to form a modified substrate S230; performing copper electroless plating on the modified substrate S240; plating a copper layer on the substrate which has undergone copper electroless plating, so as to achieve a required thickness S250; coating a photoresist S260 on the substrate plated with the copper layer; disposing a photomask outside the substrate to perform semiconductor exposure and development and thereby define antenna width and clearance S270; and performing the shaping of an antenna metal wiring with a copper etching plating solution S280.

Before performing copper electroless plating, it is necessary to cleanse the substrate surface with acetone and then perform sensitization and activation on the substrate with SnCl₂ and PdCl₂, wherein the required chemical formula and operation conditions are shown in Table 1 and Table 2. Then, the substrate is put in a copper electroless plating solution to undergo a copper electroless plating process, wherein the required plating bath ingredients and operation conditions are shown in Table 3. Afterward, a copper layer is deposited and plated on the substrate to achieve a required thickness, wherein the required plating bath ingredients and operation conditions are shown in Table 4.

TABLE 1
formula and operation conditions for sensitization

| SnCl₂•2H₂O | 10~20 | g/L |
|---|---|---|
| HCl | 15~25 | g/L |
| temperature | room temperature | |
| duration | 5~10 | minutes |

TABLE 2
formula and operation conditions for activation

| PdCl₂ | 0.1~0.5 | g/L |
|---|---|---|
| HCl | 1~3 | g/L |
| temperature | room temperature | |
| duration | 5~10 | minutes |

TABLE 3
plating bath formula and operation conditions
for copper electroless plating

| CuSO4•2H₂O | 6~8 | g/L |
|---|---|---|
| HCHO | 24%, 15~20 ml/L | |
| EDTA | 20 | g/L |
| NaOH | 10 | g/L |
| copper plating additive | 80 | ml/L |
| reaction temperature | 25~35° | C. |

| | |
|---|---|
| pH | 11.5~12 |

TABLE 4
plating bath formula and operation conditions
for copper electroless plating

| CuSO4•2H₂O | 100 | g/L |
|---|---|---|
| H₂SO₄ | 200 | g/L |
| Cl⁻ | 0.04 | g/L |
| additive | — | |
| temperature | 25° | C. |

| | |
|---|---|
| current density | 1-2ASD |

The step of defining antenna wiring width and clearance by photolithography is performed by coating a photoresist on the substrate plated with copper, exposing the metal antenna wiring by etching, removing the photoresist, and performing a wiring surface nickel-gold plating process (SF manufacturing process, Ni: 5 μm; Au: 0.1 μm). Therefore, the nonplanar 3D antenna manufactured according to the present invention has a miniaturized metal wiring with a high aspect ratio.

The above embodiments are illustrative of the features and effects of the present invention rather than restrictive of the scope of the substantial technical disclosure of the present invention. Persons skilled in the art may modify and alter the above embodiments without departing from the spirit and scope of the present invention. Therefore, the scope of the protection of rights of the present invention should be defined by the appended claims.

What is claimed is:

1. A manufacturing method of antenna shaping, the method comprising the steps of:
(1) providing a nonplanar 3D substrate;
(2) coarsening and modifying a surface of the substrate to form a modified substrate and therefore enhance uniformity of back-end metal plated layer by surface treatment of the substrate;
(3) forming a copper layer on the modified substrate, followed by plating copper on a surface of the modified substrate with a precise plating bath to cover the copper layer, so as to enhance quality of copper plating of the modified substrate; and
(4) defining antenna clearance and width by 3D photolithography to efficiently reduce a width of an antenna metal wiring to microscale and therefore reduce a range of its low-frequency application to less than 2 GHz.

2. The method of claim 1, wherein the substrate undergoes surface coarsening by one of chemical etching and mechanical means.

3. The method of claim 1, wherein the substrate is a non-conductor substrate.

4. The method of claim 1, wherein the substrate is made of one of an engineering plastic and a ceramic.

5. The method of claim 1, wherein impurities are removed from the substrate chemically or mechanically, and substrate surface modification is performed chemically or physically, to achieve a surface droplet contact angle of less than 90 degrees and render the substrate hydrophilic.

6. The method of claim 5, wherein, when subjected to a plasma process, the modified substrate achieves the surface droplet contact angle of less than 90 degrees and becomes hydrophilic.

7. The method of claim 1, wherein the step of forming a copper layer on the modified substrate includes a copper electroless plating process and a copper electroplating process.

8. The method of claim 7, wherein the copper electroless plating process includes a processing process for sensitizing the substrate with SnCl₂ and activating the substrate with PdCl₂.

9. The method of claim 1, wherein the step of shaping an antenna metal wiring by 3D photolithography includes shaping the antenna metal wiring with a copper etching plating solution.
